(19) United States
(12) Patent Application Publication
(10) Pub. No.: US 2006/0005226 A1
(43) Pub. Date: Jan. 5, 2006

(54) System and method for synchronization of a portable media player to a user's profile

(76) Inventor: Peter S. Lee, Calabasas Park, CA (US)

Correspondence Address: THE WALT DISNEY COMPANY;C/O GREENBERG TRAURIG LLP, 2450 COLORADO AVENUE SUITE 400E, SANTA MONICA, CA, 90404, US

(21) Appl. No.: 11/126,821

(22) Filed: May 10, 2005

Related U.S. Application Data
(60) Provisional application No. 60/572,018, filed on May 17, 2004.

(51) Int. Cl. H04N 7/16

(52) U.S. Cl. 725/141

(57) ABSTRACT

A system for synchronizing a portable media player for downloading of content to said player and playing the downloaded content on the player including profile synchronizing means associated with the player for synchronizing content downloaded to said player related to the profile of the user of the player.

### RELATIONSHIP TO PRIOR APPLICATIONS

This application claims the benefit of provisional application Ser. No. 60/572,018, filed May 17, 2004, the content of which is incorporated by reference herein in its entirety.

### BACKGROUND

1. Field of the Disclosure

The disclosure relates to portable media players; and, more particularly, to synchronization of such players relating to a user's profile.

2. Related Art

Portable media players (PMP) are well known in the art. These players are usually pocket size devices that can store hundreds of movies, games, or other media on a built-in hard drive, memory card, or removable storage, and play the same back when desired.

Data content providers download a wide variety of content to such players, usually requested by the user.

### SUMMARY

It is an object of this disclosure to download content to a portable media player based on the user's profile.

It is a further object of this disclosure to download content to a portable media player related to information previously provided by the user.

It is still further an object of this disclosure to download content to a portable media player related to information obtained from the users prior downloads over a period of time.

It is another object of this disclosure to download content to a portable media player based on the mood of the user of the player.

### BRIEF DESCRIPTION OF THE PREFERRED EMBODIMENT

A portable media player is one which is adapted to store and playback various media that may be downloaded after purchase, or purchased by subscription or the like, such as:

1. Personal video content;

2. Media company content, including, but not limited to, movies, broadcast content, trailers, etc.;

3. Music;

4. Voice recordings;

5. Photos and other images;

6. Data in general.

As particularly contemplated on the present disclosure, the provider of media content can develop a profile of the user both initially, based on input from the user, or over a period of time. A user's profile can be developed initially by use of a questionnaire or the like to see what type of media or other content a user is interested in. For example, a user may like action movies or role playing video games. Thus, the provider would have a profile on the user of the player and download a movie, such as an action movie, to the player depending on the financial arrangement with the user. For example, a user may pre-authorize such downloads or authorize the same when advised of the subject matter.

Over time, the provider of such content can refine the initial user profile depending on the content actually downloaded. For example, the downloaded history of the player may show that the user likes rock concerts which was not indicated in the user's original questionnaire or original profile. The content provider will be able to advise the user that a particular concert is available for downloading.

Another profiling of the user may be related to the mood of the user at a particular time. For example, a sensor may be provided in a computer touch pad coupled to the computer which analyzes the mood of the user and sends a signal to the content provider over the internet. Such sensing means may be provided in the player itself and analyzes the mood of the user when the user accesses content on the player. For example, the user's profile over time may show a liking for animated films and the user's mood may be happy when-viewing such films. The sensor in the pad or player detects such happy mood and suggests a particular animated film to the user.

Thus, merely holding the portable media player or touching the pad may detect the mood of the user. This may be accomplished by detecting the temperature of the user, the user's pulse, perspiration of the user, etc. The analysis is used by the portable media player or transmitted to the content provider and content relating to the user's mood is either selected from the current files on the player or is downloaded to the user of the portable media player. These files are then used to generate a playlist based on the user's mood. Such download may be further personalized to the user. The mood of the user can be used to determine what future content should be delivered to the user. The aforementioned playlist may be generated using fuzzy logic technology from the mood signals picked up, from past viewing experiences, initial questionnaire, etc.

It can be seen that content may be downloaded to a portable media device during synchronization based on the particular user's profile. For example, the content may be limited to certain MPAA movie ratings (or the parent's own ratings parameters, if a child is involved), particular characters, themes, etc. Alternatively, the content may be filtered for certain moods of the user. As discussed, a biometric sensor may be provided in a computer pad or in the portable media device actuated by touch to determine the user's mood automatically and download and/or play compatible content depending on the user's mood.

It can be seen that there is disclosed a system for synchronizing a portable media player for downloading of content to the player and playing the downloaded content on the player. The system includes a profile synchronizing means associated with the player for synchronizing content downloaded to the player related to the profile of the user of the player. The profile synchronizing means may synchronizes content related to a profile of the user of the player entered into the player and conveyed to the portable media player or to the provider of the content at the time of initiation of the player for downloading of content. The synchronized content related to the profile of the user of the player may be developed over a period of time due to the type of content previously downloaded by the user.

The profile associated with the user of the player may synchronize content on the player depending on the mood of the user of the player. The profile synchronizing means includes mood sensing means associated with the player for sensing the mood of the user of the player and conveying the sensed mood to the provider of the content. The profile synchronizing means is associated with a pad coupled to either the portable media player or to a computer having the mood sensing means therein electronically coupled to either the portable media player or to a computer.

Temperature detecting means may be associated with the player for detecting the temperature of the player or user. Pulse monitoring means may also be provided associated with the player for monitoring the pulse of the user of the player.

Perspiration detection means may be provided associated with the player for detecting changes in perspiration of the user of the player. Fuzzy logic means may be associated with the synchronizing means for determining the mood of the user of the player.

The profile conveying means associated with the player may include means for conveying the profile of the player to the source of the content.

The method disclosed herein for synchronizing a portable media player to the downloading of content to the player and playing the content on the player synchronizes content downloaded to the player related to the profile of the user of the player. Playlists may be generated based on the user's mood, profile and/or past history of playback. The playlist may consist of elements of content (e.g., music, movies, television, personal video or audio, etc.) that is packaged together for playback and the user may watch the playlist in either consecutive order, randomly, and/or may skip/jump between elements in the playlist.

The synchronized content related to the profile of the user may include content related to a profile of the user of the player entered into the player at the time of initiation of use of the player by the user. Such profile of the user of the player may be developed over a period of time relating to the content previously downloaded by the user. Such content may be related to the mood of the user of the player and accomplished by providing mood sensing means in a pad electronically connected to either the portable media player or to a computer adapted to sense the mood of the user of the player and convey it electronically to the portable media player and/or to the computer. Such profile may be conveyed to the source of the content.

The temperature, perspiration and/or pulse of the user may be monitored in any suitable manner, such as by using fuzzy logic technology, and the content downloaded to the user may be synchronized accordingly.

The system disclosed herein for synchronizing a portable media player for downloading of content to the player may include content provided by a content provider or may be resident on a computer coupled to the player. The profile synchronizing means associated with the player for synchronizing content downloaded to said player may thus synchronize content from either the content provider or the content may be resident on the computer that is related to the profile of the user of said player. The downloaded content and the content resident on the computer thus provides a playlist on the portable media player that is a combination of both files previously downloaded to the portable media player and files downloaded by both the content provider and previously resident on the computer and downloaded to the portable media player.

Although the term “user” has been used to refer to the owner of the particular player, obviously other users related to the owner of the player may be included in the profiling discussed herein.

Although a particular embodiment of the disclosure is discussed, variations thereof may occur to an artisan and the scope of the disclosure should only be limited by the scope of the appended claims.

I claim:

1. A system for synchronizing a portable media player for downloading of content to said player and playing said downloaded content on said player comprising:
a) profile synchronizing means associated with said player for synchronizing content downloaded to said player related to the profile of the user of said player.

2. The system of claim 1 wherein said profile synchronizing means associated with said player synchronizes content related to a profile of the user of said player entered into said player and conveyed to the provider of said content at the time of initiation of said player for downloading of content.

3. The system of claim 1 wherein said profile synchronizing means associated with said player synchronizes content related to a profile of the user of said player developed over a period of time due to the type of content previously downloaded by said user.

4. The system of claim 1 wherein said profile associated with said the user of said player synchronizes content on said player depending on the mood of the user of said player.

5. The system of claim 4 wherein said profile synchronizing means includes mood sensing means associated with said player for sensing the mood of the user of said player and conveying said sensed mood to the provider of said content.

6. The system of claim 4 wherein said profile synchronizing means is associated with a pad coupled to either said portable media player or to a computer having said mood sensing means therein electronically coupled to either said portable media player or to a computer.

7. The system of claim 4 including temperature detecting means associated with said player for detecting the temperature of the user of said player.

8. The system of claim 5 including temperature detecting means associated with said player for detecting the temperature of the user of said player.

9. The system of claim 6 including temperature detecting means associated with said player for detecting the temperature of the user of said player.

10. The system of claim 4 including pulse monitoring means associated with said player for monitoring the pulse of the user of said player.

11. The system of claim 5 including pulse monitoring means associated with said player for monitoring the pulse of the user of said player.

12. The system of claim 6 including pulse monitoring means associated with said player for monitoring the pulse of the user of said player.

13. The system of claim 4 including perspiration detection means associated with said player for detecting changes in perspiration of the user of said player.

14. The system of claim 5 including perspiration detection means associated with said player for detecting changes in perspiration of the user of said player.

15. The system of claim 6 including perspiration detection means associated with said player for detecting changes in perspiration of the user of said player.

16. The system of claims 4 including fuzzy logic means associated with said synchronizing means for determining the mood of the user of said player.

17. The system of claim 5 including fuzzy logic means associated with said synchronizing means for determining the mood of the user of said player.

18. The system of claim 6 including fuzzy logic means associated with said synchronizing means for determining the mood of the user of said player.

19. The system of claim 1 including profile conveying means associated with said player for conveying said profile to the source of said content.

20. A method for synchronizing a portable media player for downloading of content to said player and playing said content on said player comprising the steps of:
a) synchronizing content downloaded to said player related to the profile of the user of said player;
b) generating selectable playlists based on the user's mood, profile and/or past history of playback, said playlist consisting of elements of content (e.g., music, movies, television, personal video or audio, etc) that is packaged together for playback; and
said generated playlist being generated in a manner such that a user may watch said playlist in either consecutive order, randomly, and/or skip/jump between elements in the playlist.

21. The method of claim 20 wherein the step of synchronizing content related to the profile of said user includes the step of synchronizing content related to a profile of the user of said player entered into said player at the time of initiation of use of said player by said user.

22. The method of claim 20 wherein the step of synchronizing content related to the profile of said user includes the step of synchronizing content related to a profile of the user of said player developed over a period of time relating to the content previously downloaded to said player by said user.

23. The method of claim 20 wherein the step of synchronizing content includes the step of synchronizing content on said player relating to the mood of said user of said player.

24. The method of claim 23 wherein the step of synchronizing content relating to the mood of the user of said player includes the step of providing mood sensing means in a pad electronically connected to either a portable media player or a computer adapted to sense the mood of the user of said player and convey it electronically to the portable media player and/or to said computer.

25. The method of claim 23 wherein the step of synchronizing content relating to the mood of the user of said player includes the step of providing mood sensing means for sensing the mood of said user.

26. The method of claim 20 including the step of conveying said profile of said user to the source of said content.

27. The method of claim 20 wherein the step of synchronizing content includes the step of detecting the mood of the user of said player by monitoring the temperature of the user of said player and synchronizing content downloaded to said player based on the mood of said user that is detected.

28. The method of claim 20 wherein the step of synchronizing content includes the step of detecting the mood of the user of said player by monitoring the pulse of the user of said player and synchronizing content downloaded to said player based on the mood of said user that is detected.

29. The method of claim 20 wherein the step of synchronizing content includes the step detecting the mood of the user of said player by monitoring any change in perspiration of the user of said player and synchronizing content downloaded to said player based on the mood of said user that is detected.

30. The method of claim 20 including the step of determining the mood of the user of said player using fuzzy logic.

31. The method of claim 27 including determining the mood of the user of said player using fuzzy logic.

32. The method of claim 28 including determining the mood of the user of said player using fuzzy logic.

33. The method of claim 29 including determining the mood of the user of said player using fuzzy logic.

34. A system for synchronizing a portable media player for downloading of content to said player that is provided by a content provider or resident on a computer coupled to said player and playing said downloaded content on said player comprising:
a) profile synchronizing means associated with said player for synchronizing content downloaded to said player from either said content provider or resident on said computer that is related to the profile of the user of said player.

35. The system of claim 34 wherein said downloaded content and said content resident on said computer provides a playlist on said portable media player that is a combination of both files previously downloaded to said portable media player and files downloaded by both said content provider and previously resident on said computer and downloaded to said portable media player.

36. A method for synchronizing a portable media player for downloading of content to said player that is provided by a content provider or resident on a computer coupled to said player and playing said downloaded content on said player comprising the steps of:
synchronizing content downloaded to said player from either said content provider or resident on said computer that is related to the profile of the user of said player.

37. The method of claim 36 wherein the step of synchronizing said content includes the step of providing a playlist on said portable media player that is a combination of both files previously downloaded to said portable media player and files downloaded by both said content provider and previously resident on said computer and downloaded to said portable media player.
